(19) United States
(12) Patent Application Publication
(10) Pub. No.: US 2006/0250953 A1
(43) Pub. Date: Nov. 9, 2006

(54) Quality of service admission control based on congestion of backhaul connection

(75) Inventors: Christopher F. Mooney, Livingston, NJ (US); Xin Wang, Parsippany, NJ (US); Tomas S. Yang, Parsippany, NJ (US); Yang Yang, Parsippany, NJ (US); Lily H. Zhu, Parsippany, NJ (US)

Correspondence Address: WILLIAMS, MORGAN & AMERSON, 10333 RICHMOND, SUITE 1100, HOUSTON, TX, 77042, US

(73) Assignee: Lucent Technologies, Inc.

(21) Appl. No.: 11/105,318

(22) Filed: Apr. 13, 2005

(51) Int. Cl. H04L 12/26

(52) U.S. Cl. 370/229

(57) ABSTRACT

The present invention provides a method of communication using at least one base station and at least one switch. The method includes allocating at least one resource of at least one backhaul connection between said at least one base station and said at least one switch based upon at least one indication of congestion associated with said at least one backhaul connection.

### BACKGROUND OF THE INVENTION

1. Field of the Invention

This invention relates generally to communication systems, and, more particularly, to wireless communication systems.

2. Description of the Related Art

Conventional wireless communication networks typically include a plurality of base stations that provide wireless connectivity to one or more geographical areas, which are usually referred to as cells. Mobile units may establish wireless communication links with one or more of the base stations according to one or more wireless communication protocols, such as Universal Mobile Telecommunication Service (UMTS), Global System for Mobile communications (GSM), Code Division Multiple Access (CDMA, CDMA 2000), and the like. Exemplary mobile units include cellular telephones, personal data assistants, smart phones, text messaging devices, laptop computers, and the like.

The base stations are typically connected to the wireless communication network by a switch, such as a Radio Network Controller (RNC) or a Mobile Switching Center (MSC), by a backhaul connection. Multiple base stations and switches may share the same physical backhaul facility to achieve trucking efficiency. The backhaul capacity is usually considered to be one of the scarcest resources in the wireless communication network, at least in part because service providers often lease portions of the backhaul connection. For example, a service provider may lease a portion of a T1 connection to use as a backhaul connection. Service providers may then engineer the backhaul connection so that it does not cover the worst-case scenario in which all base stations transmit and receive at their individual maximum capacities at the same time. This deliberate under-engineering of the backhaul connection may cause backhaul contentions to arise between different users and/or different data flows.

Conventional techniques for backhaul admission control and resource allocation treat the data provided by each data application as Best Effort data. Thus, when the backhaul connection becomes congested, e.g. when one or more of the base stations are transmitting near capacity, user data may be buffered in a first-in-first-out data buffer. Depending on the level of congestion, some packets may even be dropped. Data applications may experience large delays, jitter, and numerous data retransmissions when the backhaul connection is congested. Consequently, the congested backhaul connection may not meet the performance and/or quality-of-service (QoS) requirements demanded by delay sensitive applications, such as Voice over Internet Protocol (VoIP), video telephony, interactive gaming, and the like. For example, some wireless networks (e.g., CDMA2000 HRPD Rev-A) support application QoS requirements such as a maximum delay, a jitter level, average data rate, peak data rate, and the like. These wireless networks may also support multiple flows for each user, and each flow may have an associated suite of QoS requirements that must be met by the wireless communication network. Congested backhaul connections may not meet the requirements of these wireless networks.

The present invention is directed to addressing the effects of one or more of the problems set forth above.

### SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the present invention, a method is provided for communication using at least one base station and at least one switch. The method includes allocating at least one resource of at least one backhaul connection between said at least one base station and said at least one switch based upon at least one indication of congestion associated with said at least one backhaul connection.

### BRIEF DESCRIPTION OF THE DRAWINGS

The invention may be understood by reference to the following description taken in conjunction with the accompanying drawings, in which like reference numerals identify like elements, and in which:

FIGS. 1A and 1B conceptually illustrate first and second exemplary embodiments of a wireless communication network, in accordance with the present invention;

FIG. 2 conceptually illustrates one embodiment of a router, in accordance with the present invention;

FIG. 3 conceptually illustrates one exemplary embodiment of a data packet including a bit indicative of congestion, in accordance with the present invention;

FIG. 4 conceptually illustrates one exemplary embodiment of a backhaul connection, in accordance with the present invention; and

FIG. 5 conceptually illustrates one exemplary embodiment of a method of allocating resources based on an indication of congestion in a backhaul connection, in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

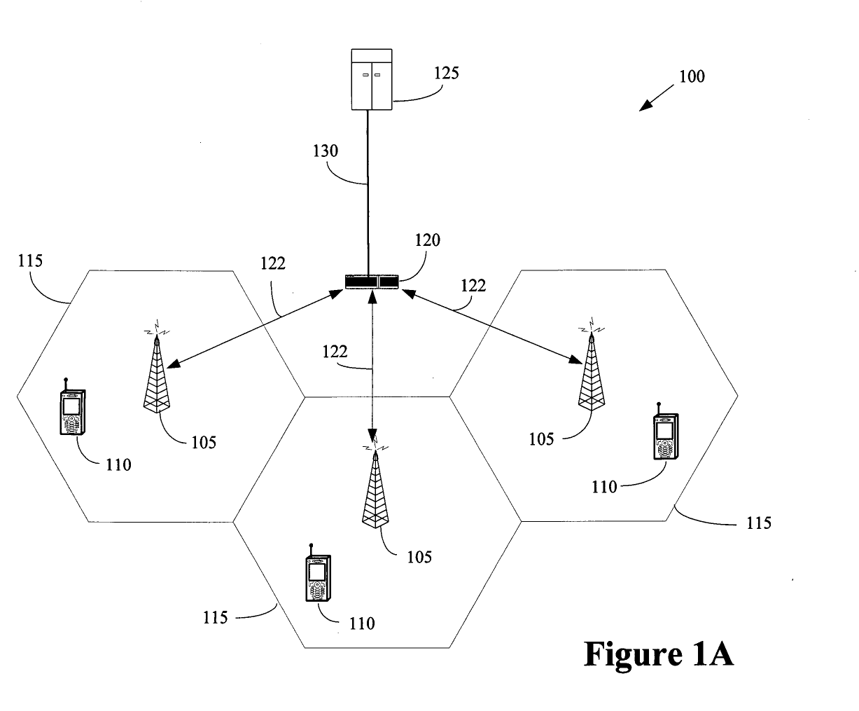

FIG. 1A conceptually illustrates a first exemplary embodiment of a wireless communication system 100. In the illustrated embodiment, one or more base stations 105 provide wireless connectivity to mobile units 110 in geographic areas, referred to hereinafter as cells 115, associated with each base station 105. Persons of ordinary skill in the art should appreciate that the specific number of base stations 105, mobile units 110, and cells 115 are not material to the present invention and any number of base stations 105, mobile units 110, and cells 115 may be included in the wireless communication system 100. In various alternative embodiments, the base stations 105 may provide wireless connectivity according to any desirable protocol including, but not limited to, a Universal Mobile Telecommunication Service (UMTS) protocol, a Global System for Mobile communications (GSM) protocol, a Code Division Multiple Access (CDMA, CDMA 2000) protocol, an Evolved, Data Optimized (EVDO) protocol, and the like. The base stations 105 may also provide wireless connectivity according to protocols such as Bluetooth, one or more IEEE 802.11 protocols, and the like.

The base stations 105 are communicatively coupled to at least one router 120 by a direct (or immediate) link 122. For example, the direct link 122 may be a T1 line. However, in various alternative embodiments, the base stations 105 may be communicatively coupled to the router 120 using a wired connection, a wireless connection, or any combination thereof. Persons of ordinary skill in the art should also appreciate that the base stations 105 may be communicatively coupled to the router 120 via other intermediate devices (not shown) such as hubs, switches, and the like. The base stations 105 can receive data from the mobile units 110 and provide this data to the router 120. The base stations 105 can also receive data from the router 120 that is intended for one or more of the mobile units 110. In one embodiment, the data provided to, or received from, the router 120 includes one or more data packets, which may be formed according to protocols such as an Internet Protocol (IP).

The data provided to, or received from, the router 120 may be associated with one or more application data flows. The term “application data flow,” as used herein, refers to data flows associated with a particular application associated with one or more of the mobile units 110. The application data flow may refer to packets that are formed, transmitted, received and/or decoded by the application and/or mobile unit 110, as well as the hardware and/or software used to form, transmit, receive, and/or decode the packets. In various alternative embodiments, a mobile unit 110 may be capable of supporting a single application data flow and/or a plurality of concurrent application data flows. For example, mobile units 110 may be able to support concurrent application data flows for multiple delay-sensitive applications, such as a VoIP application and an interactive gaming application. For another example, mobile units 110 may be able to support concurrent application data flows for delay-sensitive and non-delay-sensitive applications, such as a VoIP application and an Internet browsing application.

In the first exemplary embodiment of the wireless communication system 100 shown in FIG. 1A, the router 120 is communicatively coupled to a switch 125 by a dedicated link 130, which may also be referred to as a long haul link 130. For example, the dedicated link 130 may be a dedicated line such as a dedicated link like a DS3 line, an OC3 line, or another types of long haul line. In this embodiment, the router 120 may aggregate information provided by the base stations 105 and then attempt to transmit the aggregated information to the switch 125 over the dedicated link 130. The router 120 may also receive information intended to be transmitted to one or more of the base stations 105 from the switch 125 over the dedicated link 130. The router 120 may then attempt to provide the information received from the switch 125 to the appropriate base station 105. Operation of an exemplary embodiment of the router 120 will be discussed in detail below.

In the illustrated embodiment, the router 120 and the dedicated link 130 form a backhaul connection between the mobile units 110 and the switch 125. As used herein, the term “backhaul connection” refers to a connection that transmits information between one or more access points or base stations 105 and one or more switches 125 In the illustrated embodiment, the backhaul connection also includes the immediate link 122 and the long haul 130. The one or more switches 125 may then be connected to another network (not shown). In some embodiments of wireless communication systems, the backhaul connection provides a communication link between one or more base stations 105 and a Radio Network Controller (RNC). However, persons of ordinary skill in the art should appreciate that the backhaul connection may connect other types of devices. For example, the endpoints of the backhaul connection may include wireless access points, Mobile Switching Centers (MSC), and the like. The backhaul connection may also include wired connections, wireless connections, or any combination thereof.

FIG. 1B conceptually illustrates a second exemplary embodiment of the wireless communication system 100. Portions of the second exemplary embodiment of the wireless communications system 100 may operate in substantially the same manner as described above with regard to the first exemplary embodiment of the wireless communication system 100 shown in FIG. 1A. In the interest of clarity, these portions of the second exemplary embodiment of the wireless communications system 100 will not be discussed further. The second exemplary embodiment of the wireless communications system 100 differs from the first exemplary embodiment in that the backhaul connection includes a router 135 that is communicatively coupled to a network 140 and one or more other routers 145. However, persons of ordinary skill in the art should appreciate that the second exemplary embodiment, which includes the network 140 and the two routers 145, is intended to be illustrative and not to limit the present invention.

In the second exemplary embodiment, the router 135 may aggregate information provided by the base stations 105 and then attempt to transmit the aggregated information to the switch 125 via the network 140 and/or one or more of the routers 145. The router 135 may also receive information from the switch 125 intended to be transmitted to one or more of the base stations 105. The router 135 may then attempt to provide the information received from the switch 125 to the appropriate base station 105. In various alternative embodiments, the network 140 may include other devices and/or links that are not shown in FIG. 1B. For example, the network 140 may include routers, hubs, switches, immediate links, aggregate links, or any combination thereof. In the illustrated embodiment, the router 135, the network 140, and/or the routers 145 may form a backhaul connection between the mobile units 110 and the switch 125.

Referring now to FIGS. 1A and 1B, an indication of congestion in the backhaul connection may be used to determine whether to allocate one or more resources of the backhaul connection. In one embodiment, the indication of congestion in the backhaul connection is provided to the switch 125, which may use the indication of congestion to determine whether or not to admit or decline new application data flows. As will be discussed in detail below, if any segment of the backhaul has its ECN bit set, the backhaul will be marked as congested. For example, the routers 120, 135, 145 and/or one or more portions of the network 140 may modify one or more bits, such as the ECN bit, in data packets transmitted by the backhaul connection to indicate that congestion exists in the corresponding device. The switch 125 may then access the one or more bits in the data packets and use them to determine whether or not to admit new application data flows.

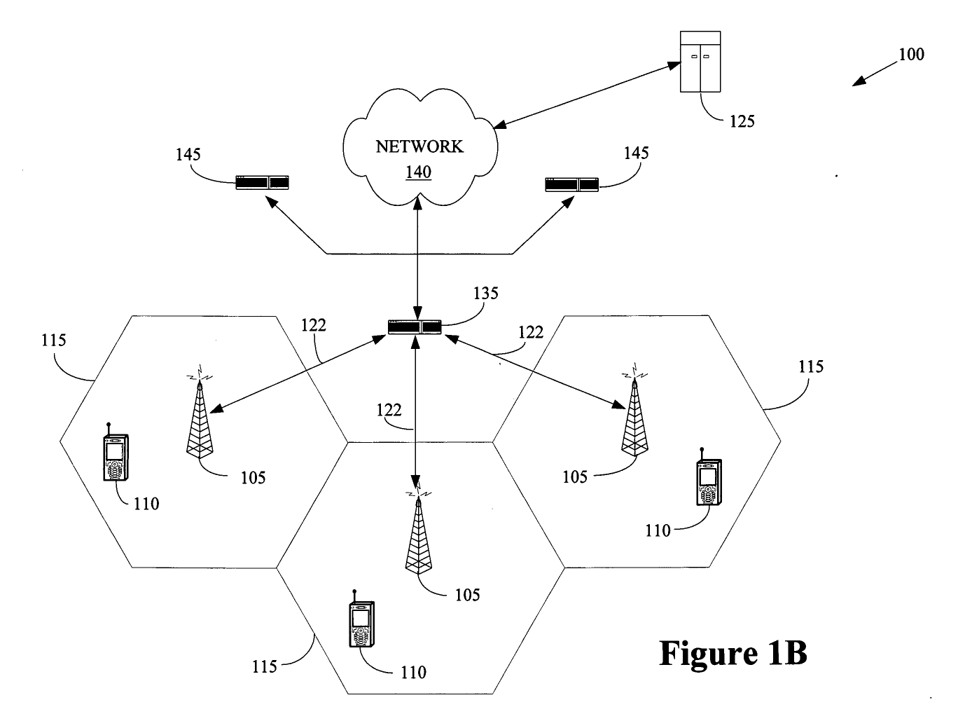

FIG. 2 conceptually illustrates one embodiment of a router 200. In the illustrated embodiment, the router 200 receives information via a line 205. Although a single line 205 is shown in FIG. 2, this is not intended to limit the present invention. Persons of ordinary skill in the art should appreciate that the router 200 may receive information associated with one or more application data flows and thus may include one or more lines 205 for receiving this information. In one embodiment, the router 200 receives data packets associated with one or more application data flows.

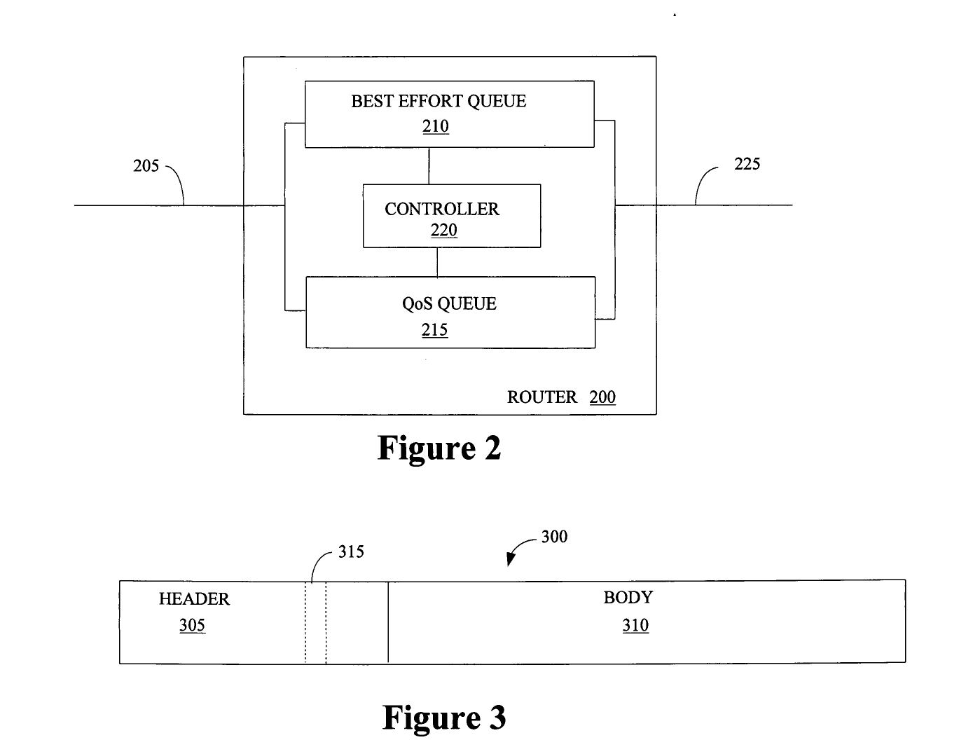

FIG. 3 conceptually illustrates one exemplary embodiment of a data packet 300. In the illustrated embodiment, the data packet 300 includes a header 305 and a body 310. Techniques and/or protocols for forming the header 305 and the body 310 are known to persons of ordinary skill in the art and so only those aspects of the data packet 300 that are relevant to the present invention will be discussed in detail herein. In one embodiment, the header 305 includes a bit 315 indicative of congestion. For example, the bit 315 may be set to a value of “0” to indicate that the data packet 300 has not been processed and/or transmitted by any devices and/or links that were experiencing congestion concurrently with or substantially before the device and/or link processed or transmitted the data packet 300. Alternatively, the bit 315 may be set to a value of “1” to indicate that the data packet 300 has been processed and/or transmitted by one or more devices and/or links that were experiencing congestion concurrently with or substantially before the device and/or link processed or transmitted the data packet 300. However, persons of ordinary skill in the art should appreciate that any number of bits indicative of congestion may be used and that these bits may be deployed at any location within the data packet 300.

In one embodiment, the bit 315 may be an Explicit Congestion Notification (ECN) bit, as defined by RFC3168 for the Internet Protocol. The ECN bit was added to IPv4 TOS byte and IPv6 Traffic Class Octet in tunnel mode header construction to be compatible with the use of ECN bits. The details of how the ECN bit is generated and transported through IP network can be found in RFC3168 and so only those aspects of bit generation and transportation that are relevant to the present invention will be discussed herein.

Referring back to FIG. 2, the router 200 includes a best effort queue 210 and a Quality of Service (QoS) queue 215. A controller 220 directs received data packets to either the best effort queue 210 or the Quality of Service queue 215. In one embodiment, the controller 220 directs the data packets to either the best effort queue 210 or the Quality of Service queue 215 based upon a service class associated with the data packets. For example, data packets associated with application data flows that are not delay-sensitive, such as application data flows associated with Internet browsing, may be directed to the best effort queue 210. For another example, data packets associated with application data flows that are delay-sensitive, such as VoIP packets, interactive gaming packets, video packets, and the like, may be directed to the Quality of Service queue 215.

Data packets in the best effort queue 210 may be handled according to a best effort algorithm. Best effort algorithms are known to persons of ordinary skill in the art and will not be discussed further herein. However, it should be noted that best effort algorithms do not provide any guarantee that the data packets in the best effort queue 210 will be delivered to their intended destination. Accordingly, the router 200 is not typically able to provide Quality of Service guarantees for the data packets in the best effort queue 210, and these data packets may be delayed and/or dropped when the router 200 is congested.

Data packets in the Quality of Service queue 215 may be subject to one or more Quality of Service requirements. For example, some wireless networks (e.g., CDMA2000 HRPD Rev-A) support application QoS requirements such as a maximum delay, a jitter level, average data rate, peak data rate, and the like. As discussed above, congestion in the router 200 may limit the ability of the router 200 to meet the Quality of Service requirements associated with the data packets in the Quality of Service queue 215. The controller 210 may therefore modify the data packets to indicate congestion in the router 200. For example, the controller 210 may use a logical-OR operation to modify a bit, such as the bit 315 shown in FIG. 3, to indicate congestion in the router 200. However, in alternative embodiment the controller 210 may use any desirable operation to modify the bit to indicate congestion in the router 200. In one embodiment, the router 200 may modify the bit indicative of congestion based on configurable per-router-queue/per service-class thresholds.

The router 200 may provide the data packets, and the bit indicative of congestion, via a line 225. Although a single line 225 is shown in FIG. 2, this is not intended to limit the present invention. Persons of ordinary skill in the art should appreciate that the router 200 may provide information associated with one or more application data flows and thus may include one or more lines 225 for providing this information to one or more other devices (not shown). In one embodiment, the router 200 provides data packets associated with one or more application data flows. The router 200 may be a portion of a backhaul connection and thus the bit indicative of congestion in the router 200 may be used to allocate resources of the backhaul connection, as will be discussed in detail below.

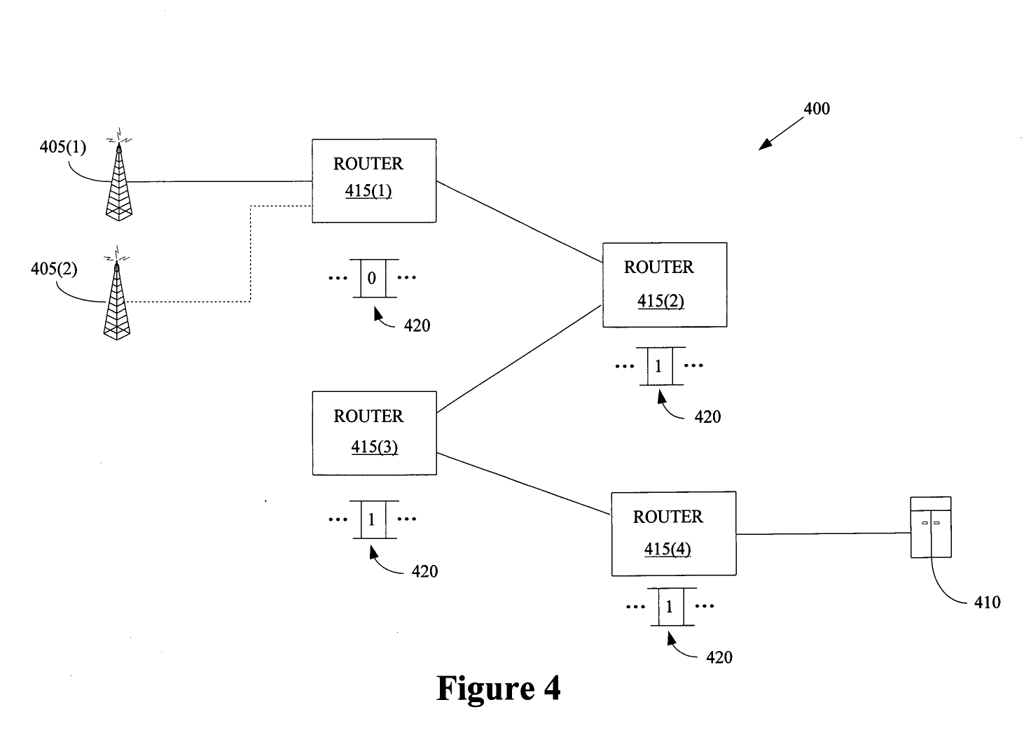

FIG. 4 conceptually illustrates one embodiment of a backhaul connection 400. In the illustrated embodiment, the backhaul connection 400 connects base stations 405(1-2) to a radio network controller 410. The backhaul connection 400 includes a plurality of routers 415(1-4). Persons of ordinary skill in the art should appreciate that the embodiment shown in FIG. 4 is illustrative and not intended to limit the present invention. For example, alternative embodiments may include more or fewer base stations, routers, and/or radio network controllers. A value of a bit 420 indicative of congestion in the backhaul connection 400 is shown proximate to each of the routers 415(1-4) to indicate the value of the bit 420 substantially after it has or has not been modified by the router 415(1-4) to indicate congestion in the router 415(1-4), as discussed above.

The value of the bit 420 may be initialized to a value of “0,” which is indicative of an absence of congestion in the backhaul connection 400. In the illustrated embodiment, the router 415(1) is receiving and/or transmitting information associated with one or more application data flows associated with the base station 405(1), as indicated by the solid line. The router 415(1) is not congested and so does not modify the value of the bit 420. The router 415(2) is congested and performs a logical-OR of the value of the bit 420 with the value “1” that indicates congestion in the router 415(2). Accordingly, the value of the bit 420 is modified to “1” to indicate congestion in the backhaul connection 400. The router 415(3) is not congested and performs a logical-OR of the value of the bit 420 with the value “0” that indicates no congestion in the router 415(3). Accordingly, the value of the bit 420 remains “1” to indicate congestion in the backhaul connection 400. The router 415(4) is congested and performs a logical-OR of the value of the bit 420 with the value “1” that indicates congestion in the router 415(4). Accordingly, the value of the bit 420 remains “1” to indicate congestion in the backhaul connection 400.

The radio network controller 410 may then access the value of the bit 420 to determine whether or not the backhaul connection 400 is congested. In the illustrated embodiment, the value of the bit 420 accessed by the radio network controller 410 is “1,” which indicates that the backhaul connection 400 is congested. Accordingly, the radio network controller 410 may allocate one or more resources of the backhaul connection 400 based upon the value of the bit 420. For example, the base station 405(2) may request access to the backhaul connection 400 for a new application data flow, as indicated by the dashed line. However, since the backhaul connection 400 is already congested, as indicated by the value of the bit 420, the radio network controller 410 may decline the request for the new application data flow.

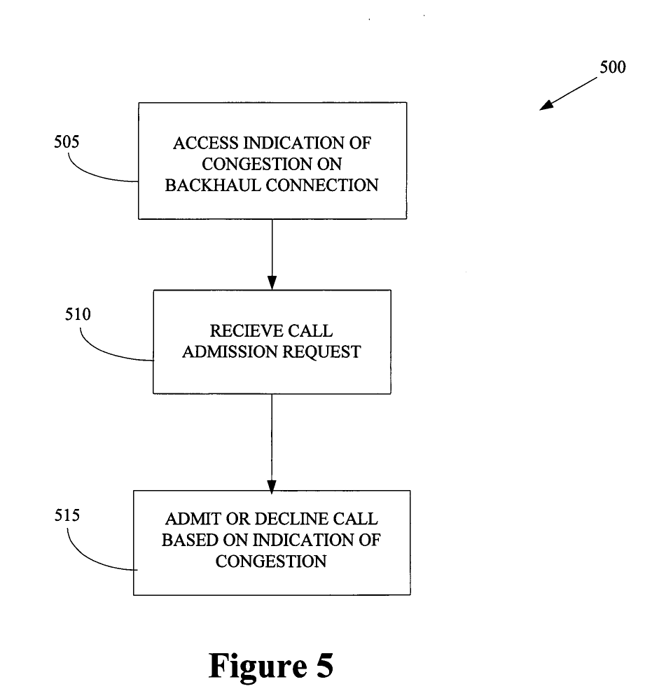

FIG. 5 conceptually illustrates one exemplary embodiment of a method 500 of allocating resources based on an indication of congestion in a backhaul connection. In the illustrated embodiment, an indication of congestion in a backhaul connection is accessed (at 505). For example, as discussed above, a bit indicative of congestion in the backhaul connection may be accessed (at 505). A call admission request, or a request for a new application data flow, may be received (at 510). Although FIG. 5 shows that the information indicative of congestion in the backhaul connection is accessed (at 505) before the request is received (at 510), the present invention is not limited to this particular order for these actions. In one alternative embodiment, the information indicative of congestion in the backhaul connection is accessed (at 505) after the request is received (at 510). In another alternative embodiment, the information indicative of congestion in the backhaul connection is accessed (at 505) concurrently with reception (at 510) of the request.

The request may then be admitted or declined (at 515) based on the indication of congestion in the backhaul connection, as discussed above. In one embodiment, a plurality of indications of congestion associated with a plurality of data packets may be received and the request may be admitted or declined (at 515) based on the plurality of indications. For example, if ECN bits in 10 consecutive frames indicate that there is congestion in the backhaul connection, then the request may be declined (at 515). However, persons of ordinary skill in the art should appreciate that any desirable algorithm for admitting or declining (at 515) the requests based upon one or more indications of congestion in the backhaul connection may be used. In one embodiment, the request may be admitted or declined (at 515) based in part on a service class associated with the call admission request or the new application data flow.

One or more of the techniques described above may have advantages over conventional practice. For example, allocating resources based upon an indication of congestion in a backhaul connection may reduce packet latency and/or the number of packets that may be dropped. Accordingly, wireless radio access networks that allocate resources based upon an indication of congestion in backhaul connections may be able to meet Quality of Service requirements associated with data packets, such as a delay-sensitive data packets that may be used for Voice over Internet Protocol (VoIP), video telephony, and/or interactive gaming.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method of communication using at least one base station and at least one switch, comprising:
allocating at least one resource of at least one backhaul connection between said at least one base station and said at least one switch based upon at least one indication of congestion associated with said at least one backhaul connection.

2. The method of claim 1, comprising accessing said at least one indication of congestion in at least one backhaul connection between said at least one base station and said at least one switch.

3. The method of claim 2, wherein accessing said at least one indication of congestion in at least one backhaul connection comprises accessing at least one indication of congestion associated with at least one of a router, a hub, a switch, an immediate link, and an aggregate link.

4. The method of claim 2, wherein accessing said at least one indication of congestion comprises accessing at least one bit in at least one packet transmitted by said at least one backhaul connection.

5. The method of claim 4, wherein accessing said at least one bit comprises accessing at least one Explicit Congestion Notification bit.

6. The method of claim 4, wherein accessing said at least one bit comprises accessing at least one bit in each of a plurality of packets transmitted by said at least one backhaul connection during a selected time period.

7. The method of claim 4, wherein accessing said at least one bit comprises accessing at least one bit formed using a logical-OR operation.

8. The method of claim 4, wherein accessing said at least one bit comprises accessing at least one bit having a value determined based on at least one of a configurable per-router to threshold and a per-class threshold.

9. The method of claim 1, wherein allocating said at least one resource of said at least one backhaul connection comprises admitting or declining at least one new application data flow based on said at least one indication of congestion in the backhaul connection.

10. The method of claim 9, comprising receiving at least one request for at least one new application data flow.

11. The method of claim 1, comprising allocating said at least one resource of said at least one backhaul connection based on a service class associated with an application data flow.

12. The method of claim 1, wherein allocating said at least one resource of said at least one backhaul connection between said at least one base station and said at least one switch comprises allocating said at least one resource of said at least one backhaul connection between said at least one base station and at least one Radio Network Controller.
